(19) United States
(12) Patent Application Publication
(10) Pub. No.: US 2025/0055283 A1
(43) Pub. Date: Feb. 13, 2025

(54) POWER DISTRIBUTION DEVICE AND DATA CENTER

(71) Applicant: Hebei Qinhuai Data Co., Limited., Zhangjiakou City (CN)

(72) Inventor: Binghua ZHANG, Zhangjiakou City (CN)

(21) Appl. No.: 18/796,055

(22) Filed: Aug. 6, 2024

(30) Foreign Application Priority Data
Aug. 9, 2023 (CN) 202311000345.2

(51) Int. Cl. H02J 3/32; H02J 9/06; H02J 13/00

(52) U.S. Cl. CPC H02J 3/32; H02J 9/06; H02J 13/00002

(57) ABSTRACT

Embodiments of the present disclosure disclose a power distribution device and a data center. The power distribution device includes a first converter, a second converter, a DC energy accumulator, and a controller. The first converter is configured to convert alternating current into direct current, and the second converter is configured to convert the direct current into the alternating current. The first converter and the second converter are connected in series in a power supply circuit, where an input terminal of the first converter is electrically connected to a power grid, an output terminal of the second converter is electrically connected to a load, and the DC energy accumulator is electrically connected between the first converter and the second converter. The controller is configured to control the DC energy accumulator to supply power to the load.

### CROSS REFERENCE TO RELATED APPLICATION

This application claims priority to Chinese Patent Application No. 2023 11000345.2, titled “POWER DISTRIBUTION DEVICE AND DATA CENTER” and filed to the China National Intellectual Property Administration on August 9, the entire contents of which are incorporated herein by reference.

### TECHNICAL FIELD

Embodiments of the present disclosure relate to the field of data center technology, and more particularly, to a power distribution device and a data center.

### BACKGROUND

With the development of intelligent technologies, processing capacity of digital information is rapidly increasing. In the face of rapidly growing business demands and users' huge expectations to data processing and information exchange, number of IT devices in data centers can be continuously increased to meet the users' requirements for information network systems in terms of technical performance, data processing capacity, storage capacity, and utilization rate, etc.

In related technologies, power grids supply power to the IT devices such as servers in the data centers by means of power distribution devices. As the number of the IT devices in the data centers continuously increases, power consumption of the data centers is higher, and thus operation and maintenance costs are higher.

### SUMMARY

An objective of embodiments of the present disclosure is to provide a power distribution device, which can solve a problem of higher power consumption and higher operation and maintenance costs in a data center.

To achieve the above objective, one aspect of the embodiments of the present disclosure provides a power distribution device, which includes a first converter, a second converter, a DC energy accumulator, and a controller. The first converter is configured to convert alternating current into direct current, and the second converter is configured to convert the direct current into the alternating current. The first converter and the second converter are connected in series in a power supply circuit, where an input terminal of the first converter is electrically connected to a power grid, an output terminal of the second converter is electrically connected to a load, and the DC energy accumulator is electrically connected between an output terminal of the first converter and an input terminal of the second converter. The controller is configured to control, based on a current electricity price and a state of the DC energy accumulator, to enable the DC energy accumulator and the second converter and disable the power grid and the first converter, such that the DC energy accumulator supplies power to the load. Alternatively, the controller is configured to control to enable the power grid and the first converter and disable the DC energy accumulator and the second converter, such that the power grid supplies power to the load.

In a possible embodiment, the power distribution device also includes a first monitor and a second monitor, where the first monitor is configured to obtain the current electricity price, and the second monitor is communicatively connected to the DC energy accumulator and is configured to obtain the state of the DC energy accumulator.

The controller is communicatively connected to the first monitor and the second monitor, respectively. The controller is configured to determine whether the current electricity price is higher than a preset electricity price based on the current electricity price obtained by the first monitor, and to determine whether the DC energy accumulator is in an operative state based on the state of the DC energy accumulator monitored by the second monitor. The controller is further configured to control to enable the DC energy accumulator and the second converter and disable the power grid and the first converter when the current electricity price is higher than the preset electricity price and the DC energy accumulator is in the operative state, such that the DC energy accumulator supplies power to the load.

In a possible embodiment, the second monitor is configured to monitor power of the DC energy accumulator and electric quantity of the DC energy accumulator. The controller is communicatively connected to the second monitor, and the controller is configured to determine, based on the power and the electric quantity of the DC energy accumulator monitored by the second monitor, whether the power of the DC energy accumulator is greater than power of the load and whether the electric quantity of the DC energy accumulator is greater than preset low electric quantity. The controller is further configured to determine that the DC energy accumulator is in the operative state when the power of the DC energy accumulator is greater than the power of the load and the electric quantity of the DC energy accumulator is greater than the preset low electric quantity.

In a possible embodiment, the power distribution device also includes an electric generator, where the electric generator is connected in parallel with the power grid at the input terminal of the first converter. The controller is also configured to determine that the DC energy accumulator is in an inoperative state when the power of the DC energy accumulator is not greater than the power of the load and/or when the electric quantity of the DC energy accumulator is not greater than the preset low electric quantity. The controller is further configured to control to enable the electric generator and the first converter, disable the power grid and the first converter, and disable the DC energy accumulator and the second converter when the power grid is in a fault state and the DC energy accumulator is in the inoperative state, such that the electric generator supplies power to the load.

In a possible embodiment, the power distribution device also includes a third monitor electrically connected to the power grid, and the third monitor is configured to monitor an electric current and a voltage of the power grid. The controller is communicatively connected to the third monitor, and the controller is configured to determine whether the power grid is in the fault state based on the electric current and the voltage of the power grid monitored by the third monitor.

In a possible embodiment, the controller is further configured to control to enable the first converter and the second converter, enable the first converter and the DC energy accumulator, and disable the DC energy accumulator and the second converter when the current electricity price is not higher than the preset electricity price, such that the power grid supplies power to the load and the DC energy accumulator.

In a possible embodiment, the power distribution device also includes a third converter, where the third converter is configured to convert a type of alternating current into another type of alternating current, and the third converter is connected in series between the second converter and the load.

In a possible embodiment, the power distribution device also includes a fourth converter configured to convert a type of alternating current into another type of alternating current, where an input terminal of the fourth converter is connected in parallel with the input terminal of the first converter to the power grid, and an output terminal of the fourth converter is connected in parallel with the output terminal of the second converter to the load. The controller is communicatively connected to the fourth converter, and the controller is configured to control to enable the power grid and the fourth converter, enable the fourth converter and the load, disable the power grid and the first converter, and disable the second converter and the load when the first converter and/or the second converter are in the fault state.

In a possible embodiment, the first converter is a rectifier, and the second converter is an inverter.

To achieve the above objective, another aspect of the embodiments of the present disclosure provides a data center, which includes at least one server and the power distribution device as described in any one of the above embodiments, where an output terminal of the power distribution device is communicatively connected to the at least one server.

A DC energy accumulator and a controller are arranged in the power distribution device and the data center provided in the embodiments of the present disclosure, where the DC energy accumulator is electrically connected between the output terminal of the first converter and the input terminal of the second converter. When the power grid is in an off-peak period or a shoulder period at which the electricity price is lower and the DC energy accumulator is in the inoperative state, the controller controls to enable the power grid and the first converter and disable the DC energy accumulator and the second converter, such that the power grid supplies power to the load. When the power grid is in a peak period or sharp period at which the electricity price is higher and the DC energy accumulator is in the operative state, the controller controls to enable the DC energy accumulator and the second converter and disable the power grid and the first converter, such that the DC energy accumulator supplies power to the load. In this way, by reducing total electricity fees consumed by the load (the data center) per day, the operation and maintenance costs are significantly reduced.

### BRIEF DESCRIPTION OF THE DRAWINGS

To describe the technical solutions of the embodiments of the present disclosure more clearly, the accompanying drawings required in the description of the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of a power distribution device according to an embodiment of the present disclosure;

FIG. 2 is a control diagram of the power distribution device according to an embodiment of the present disclosure; and

FIG. 3 is a schematic diagram of another power distribution device according to an embodiment of the present disclosure.

Reference numerals in the accompanying drawings:

power distribution device 1000; first converter 110; second converter 120; third converter 130; fourth converter 140; fifth converter 150; DC energy accumulator 200; controller 300; first monitor 410; second monitor 420; third monitor 430; electric generator 500; transformer 600; bus 700; power grid 2000; and load 3000.

### DETAILED DESCRIPTION

As described in the background, there exists the problem of higher operation and maintenance costs in data centers in the related technologies. It is learned that China implements time-of-use price, which means that electricity prices of power grids vary during different time periods. Taking the electricity prices for industrial uses in Beijing as an example, electricity cost charging standards in a sharp period, a peak period, a shoulder period, and an off-peak period are as below: electricity price in the sharp period (July to September): 1.4409 yuan/kWh, the sharp period: 11:00-13:00, 20:00-21:00; electricity price in the peak period: 1.322 yuan/kWh, the peak period: 10:00-15:00, 18:00-21:00; electricity price in the shoulder period: 0.8395 yuan/kWh, the shoulder period: 7:00-10:00, 15:00-18:00, and 21:00-23:00; electricity price in the off-peak period: 0.3818 yuan/kWh, the off-peak period: from 23:00 to 7:00 a next day. As can be seen from the above, the electricity cost in the sharp period (or peak period) is several times that of off-peak period (or shoulder period). When the power grid supplies power to the data center in the off-peak period and the shoulder period and does not supply power to the data center in the sharp period and the peak period, the electricity costs may be greatly reduced for the data center.

In view of this, embodiments of the present disclosure provide a power distribution device and a data center. By providing a DC energy accumulator and a controller, the controller can control the power grid to supply power to the load when the power grid is in the off-peak period or shoulder period at which the electricity price is lower; and the controller can control the DC energy accumulator to supply power to the load when the power grid is in the peak period or sharp period at which the electricity price is higher. In this way, by reducing total electricity fees consumed by the load (the data center) per day, the operation and maintenance costs are significantly reduced.

To make the objectives, technical solutions, and advantages of the embodiments of the present disclosure clearer, the technical solutions in the embodiments of the present disclosure will be described clearly and completely below, in conjunction with the accompanying drawings in the embodiments of the present disclosure. Apparently, the described embodiments are some but not all of the embodiments of the present disclosure.

All other embodiments obtained by a person of ordinary skill in the art based on the embodiments of the present disclosure without creative efforts shall fall within the protection scope of the present disclosure. The following embodiments and features thereof may be combined with each other on a non-conflict basis.

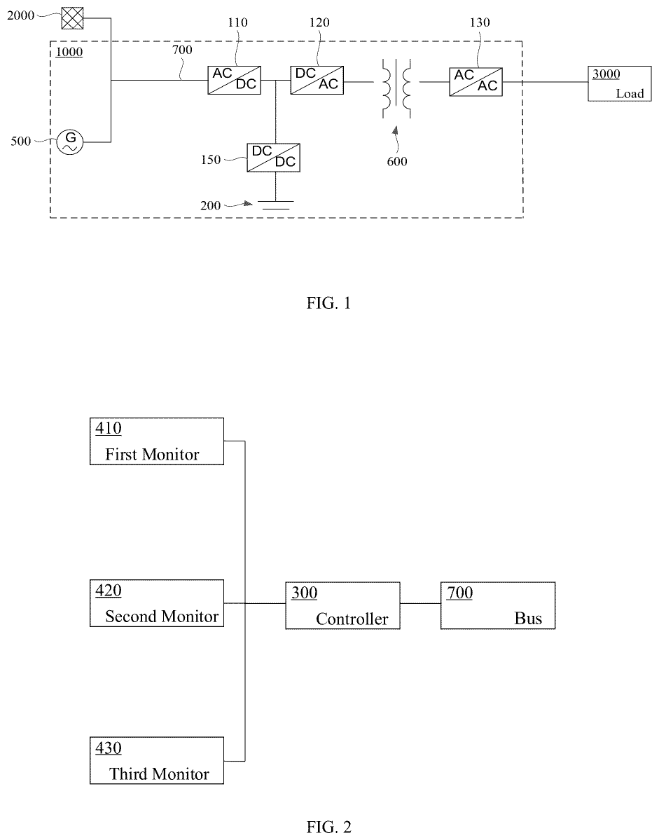

FIG. 1 is a schematic diagram of the power distribution device according to an embodiment of the present disclosure. Referring to FIG. 1, a power distribution device 1000 provided in the embodiments of the present disclosure may include a first converter 110, a second converter 120, a DC energy accumulator 200, and a controller 300. The first converter 110 may be a rectifier, i.e. an AC/DC converter. The second converter 120 may be an inverter, i.e. a DC/AC converter. The first converter 110 and the second converter 120 may be connected in series in a power supply circuit. That is, an output terminal of the first converter 110 may be electrically connected to an input terminal of the second converter 120. In addition, an input terminal of the first converter 110 may be electrically connected to a power grid 2000, and an output terminal of the second converter 120 may be electrically connected to a load 3000. That is, electricity flowing out of the power grid 2000 may flow to the load 3000 through the first converter 110 and the second converter 120 in sequence.

In addition, the DC energy accumulator 200 may be electrically connected between the output terminal of the first converter 110 and the input terminal of the second converter 120. The DC energy accumulator 200 may have a charging state and a discharging state. When there is a fault in the power grid 2000 or when the power grid 2000 is in a peak period or sharp period at which the electricity price is higher and the DC energy accumulator 200 is in an operative state, the DC energy accumulator 200 may be in the discharging state, and the controller 300 can control the DC energy accumulator 200 to supply power to the load 3000. When the power grid 2000 is in an off-peak period or a shoulder period at which the electricity price is lower, the controller 300 can control the power grid 2000 to supply power to both the load 3000 and the DC energy accumulator 200. In this way, the load 3000 uses the electricity of the power grid 2000 in different time periods. By reducing the total electricity fees consumed by the load 3000 per day, the operation and maintenance costs are significantly reduced.

Alternatively, the DC energy accumulator 200 may include a rechargeable battery and a battery management module connected electrically. The rechargeable battery may be selected from one or more of a ternary lithium-ion battery, a lithium iron phosphate battery, a lithium titanate battery, a solid-state battery, a liquid metal battery, a lead carbon battery, a lead-acid battery, and a supercapacitor. The battery management module may include a battery monitoring unit and a battery management unit connected electrically. The rechargeable battery may be electrically connected to the battery monitoring unit, and the battery management unit may be communicatively connected to the controller 300. The battery monitoring unit can monitor indicators such as voltage, electric current and temperature of the rechargeable battery in real time (regardless of the charging state or the discharging state), and report data to the battery management unit in real time or at high frequency. The battery management unit can carry out logical judgment and data processing based on the data provided by the battery monitoring unit, and control a switch module arranged at an input terminal and/or input terminal of the DC energy accumulator 200 to avoid overcharging or over-discharging the rechargeable battery. Of course, the battery management unit may also be communicatively connected to an alarm to promptly report to a user in the event of a malfunction of the DC energy accumulator 200.

When the voltage, the electric current, and the temperature of the rechargeable battery exceed a first range, the battery management module may automatically reduce the charging and discharging current to ensure system safety. When the voltage, the electric current, and the temperature of the rechargeable battery exceed a second range, the battery management module may issue instructions to the switch module and disconnect the DC energy accumulator 200 from the first converter 110 or the second converter 120 by means of the switch module to ensure the system safety.

It is worth noting that both the first range and the second range obtained above are general concepts, and need to correspond to specific range values in combination with specific monitoring types of the battery monitoring unit. For example, when the monitoring type is the voltage, if the first range is less than or equal to a first voltage, and the second range is greater than the first voltage but less than or equal to a second voltage, the battery management module may automatically reduce the charging and discharging current to ensure the system safety when the voltage of the rechargeable battery is greater than the first voltage and less than the second voltage. When the voltage of the rechargeable battery is greater than the second voltage, the battery management module controls the switch module to disconnect the DC energy accumulator 200 from the first converter 110 or the second converter 120.

In addition, the DC energy accumulator 200 may have one or more rechargeable batteries. When there are a plurality of rechargeable batteries, the battery monitoring unit may include a plurality of sub monitoring units connected to the plurality of rechargeable batteries each to each, and the plurality of sub monitoring units monitor the voltage, the electric current, and the temperature of the plurality of rechargeable batteries each to each. In this way, when a certain rechargeable battery malfunctions, the battery management module can quickly find the malfunctioning rechargeable battery for accurate troubleshooting by the user subsequently.

Referring to FIG. 1 and FIG. 2, alternatively, the power distribution device 1000 provided in the embodiments of the present disclosure may also include a first monitor 410, which can obtain a current electricity price. Specifically, the first monitor 410 can send a current electricity price inquiry request to a dispatching system of the power grid 2000, where the request may include local information, and current time information, etc. The dispatching system of the power grid 2000 may receive the current electricity price inquiry request sent from the first monitor 410, find the current electricity price corresponding to the local information and the current time information, and send the current electricity price to the first monitor 410. The first monitor 410 receives the current electricity price sent from the dispatching system of the power grid 2000, and sends the current electricity price to the controller 300. The dispatching system of the power grid 2000 may be an official website of the power grid 2000, or cloud, or may be stored in a memory.

In addition, the controller 300 may be communicatively connected to the first monitor 410, and can determine whether the current electricity price is higher than a preset electricity price based on the current electricity price obtained by the first monitor 410. When the current electricity price is higher than the preset electricity price, the controller 300 may determine that the power grid 2000 currently is in the peak period or sharp period at which the electricity price is higher. When the current electricity price is not higher than the preset electricity price, the controller 300 may determine that the power grid 2000 currently is in the off-peak period or the shoulder period at which the electricity price is lower.

The power distribution device 1000 provided in the embodiments of the present disclosure may also include a second monitor 420, which may be communicatively connected to the DC energy accumulator 200 and can obtain a state of the DC energy accumulator 200. Specifically, the second monitor 420 can monitor power of the DC energy accumulator 200 and electric quantity of the DC energy accumulator 200.

The controller 300 may be communicatively connected to the second monitor 420, and the controller 300 can determine, based on the power and the electric quantity of the DC energy accumulator 200 monitored by the second monitor 420, whether the power of the DC energy accumulator 200 is greater than power of the load 3000 and whether the electric quantity of the DC energy accumulator 200 is greater than preset low electric quantity. The controller 300 may determine that the DC energy accumulator 200 is in the operative state when the power of the DC energy accumulator 200 is greater than the power of the load 3000 and the electric quantity of the DC energy accumulator 200 is greater than the preset low electric quantity. In addition, the controller 300 may determine that the DC energy accumulator 200 is in an inoperative state when the power of the DC energy accumulator 200 is not greater than the power of the load 3000 and the electric quantity of the DC energy accumulator 200 is not greater than the preset low electric quantity.

When the current electricity price is higher than the preset electricity price and the DC energy accumulator 200 is in the operative state, the controller 300 may control to enable the DC energy accumulator 200 and the second converter 120 and disable the power grid 2000 and the first converter 110, such that the DC energy accumulator 200 supplies power to the load 3000 by means of the second converter 120, but the power grid 2000 cannot supply power to the load 3000.

Referring to FIG. 1, alternatively, the power distribution device 1000 provided in the embodiments of the present disclosure may also include an electric generator 500, which may be connected in parallel with the power grid 2000 at the input terminal of the first converter 110. That is, both the power grid 2000 and the electric generator 500 can transport electric current to the first converter 110.

When the current electricity price is higher than the preset electricity price and the DC energy accumulator 200 is in the inoperative state, oil cost for per unit of electricity generated by the electric generator 500 (i.e. unit oil cost for the electric generator 500) may be compared with cost required for the current power grid 2000 to generate per unit of electricity (i.e. the current electricity price). When the unit oil cost of the electric generator 500 exceeds the current electricity price, the controller 300 may control to enable the power grid 2000 and the first converter 110, and control to disable the electric generator 500 and the first converter 110 and disable the DC energy accumulator 200 and the second converter 120, such that the power grid 2000 supplies power to the load 3000 by means of the first converter 110 and the second converter 120, but neither the electric generator 500 nor the DC energy accumulator 200 will supply power to the load 3000.

In addition, when the unit oil cost of the electric generator 500 is less than the current electricity price, the controller 300 may control to enable the electric generator 500 and the first converter 110, and control to disable the power grid 2000 and the first converter 110 and disable the DC energy accumulator 200 and the second converter 120, such that the electric generator 500 supplies power to the load 3000 and the DC energy accumulator 200 by means of the first converter 110 and the second converter 120, but neither the power grid 2000 nor the DC energy accumulator 200 will supply power to the load 3000. In addition, when the unit oil cost of the electric generator 500 is equal to the current electricity price, either the power grid 2000 or the electric generator 500 may be selected to supply power to the load 3000. Considering service life of the electric generator 500, the power grid 2000 may be selected to supply power to the load 3000.

In summary, when the current electricity price is higher than the preset electricity price and the DC energy accumulator 200 is in the inoperative state, the controller 300 can obtain the unit oil cost of the electric generator 500 and the current electricity price, and control, based on the unit oil cost of the electric generator 500 and the current electricity price, the power grid 2000 or the electric generator 500 to supply power to the load 3000.

It is worth noting that a premise for the power grid 2000 to supply power to the load 3000 is that the power grid 2000 is in a normal state. Therefore, before obtaining the electricity price, the controller 300 may first obtain the state of the power grid 2000, and determine whether the power grid 2000 is in the normal state. Referring to FIG. 1 and FIG. 2, alternatively, the power distribution device 1000 provided in the embodiments of the present disclosure may also include a third monitor 430, which may be electrically connected to the power grid 2000 and can monitor the electric current and the voltage of the power grid 2000. The controller 300 may be communicatively connected to the third monitor 430, and the controller 300 can determine whether the power grid 2000 is in a fault state based on the electric current and the voltage of the power grid 2000 monitored by the third monitor 430.

Specifically, the controller 300 may determine, based on the electric current of the power grid 2000 monitored by the third monitor 430, whether the electric current of the power grid 2000 exceeds a preset current range. The controller 300 may determine, based on the voltage of the power grid 2000 monitored by the third monitor 430, whether the voltage of the power grid 2000 exceeds a preset voltage range. When the electric current of the power grid 2000 exceeds the preset current range and/or the voltage of the power grid 2000 exceeds the preset voltage range, the controller 300 may determine that the power grid 2000 is in the fault state rather than the normal state.

When the power grid 2000 is in the fault state and the DC energy accumulator 200 is in the inoperative state, the controller 300 may control to enable the electric generator 500 and the first converter 110, disable the power grid 2000 and the first converter 110, and disable the DC energy accumulator 200 and the second converter 120, such that the electric generator 500 supplies power to the load 3000, but neither the power grid 2000 nor the DC energy accumulator 200 supplies power to the load 3000.

It is worth noting that the power grid 2000, the electric generator 500, the first converter 110, the second converter 120, the third converter 130, and the controller 300 may all be mounted on a bus 700, which may have a plurality of switches (not shown in the figure). The controller 300 may control the switches to achieve connection or disconnection between the power grid 2000 and the first converter 110, connection or disconnection between the electric generator 500 and the first converter 110, connection or disconnection between the first converter 110 and the DC energy accumulator 200, and connection or disconnection between the DC energy accumulator 200 and the second converter 120.

Alternatively, referring to FIG. 1, the power distribution device 1000 provided in the embodiments of the present disclosure may also include a fifth converter 150, which may be a DC/DC converter and can convert a type of direct current into another type of direct current. The fifth converter 150 may be connected between a connection node between the first converter 110 and the second converter 120 and the DC energy accumulator 200, to facilitate the charging and discharging of the DC energy accumulator 200 and conversion of the direct current.

Alternatively, referring to FIG. 1, the power distribution device 1000 provided in the embodiments of the present disclosure may also include a third converter 130, which is an AC/AC converter and can convert a type of alternating current into another type of alternating current. The third converter 130 may be connected in series between the second converter 120 and the load 3000 to facilitate further conversion of the alternating current.

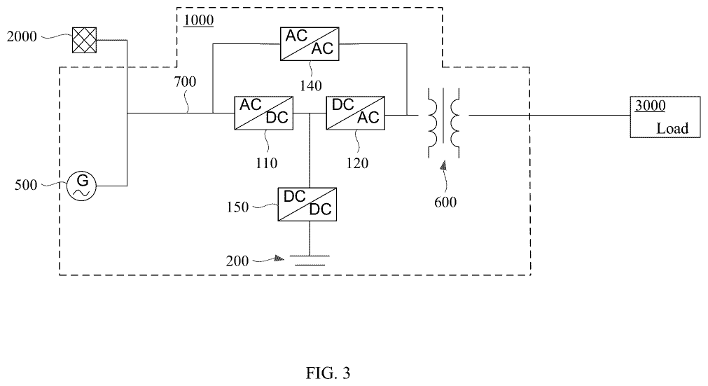

Alternatively, referring to FIG. 3, the power distribution device 1000 provided in the embodiments of the present disclosure may also include a fourth converter 140, which is an AC/AC converter and can convert a type of alternating current into another type of alternating current. An input terminal of the fourth converter 140 and the input terminal of the first converter 110 may be connected in parallel to the power grid 2000, and an output terminal of the fourth converter 140 and the output terminal of the second converter 120 may be connected in parallel to the load 3000.

The controller 300 is communicatively connected to the fourth converter 140. When the first converter 110 and/or the second converter 120 are in the fault state, the controller 300 may control to enable the power grid 2000 and the fourth converter 140, to enable the fourth converter 140 and the load 3000, to disable the power grid 2000 and the first converter 110, and to disable the second converter 120 and the load 3000, such that the electric current flowing out of the power grid 2000 directly flows to the load 3000 through the fourth converter 140. In this way, a redundancy scheme may be added for the power distribution device 1000, to avoid a situation where the device cannot run when the first converter 110 and/or the second converter 120 are damaged.

To convert a high voltage from a power source (such as the power grid 2000, the electric generator 500, and the DC energy accumulator 200) into a low voltage acceptable to the load 3000, the power distribution device 1000 provided in the embodiments of the present disclosure may also include a transformer 600. In FIG. 1, an input terminal of the transformer 600 may be electrically connected to the second converter 120, and an output terminal of the transformer 600 may be electrically connected to the load 3000. In FIG. 3, an input terminal of the transformer 600 is electrically connected to a connection node between the second converter 120 and the fourth converter 140, and an output terminal of transformer 600 is connected to the load 3000.

The embodiments of the present disclosure also provide a data center, which may include at least one server and the power distribution device 1000 as mentioned above. An output terminal of the power distribution device 1000 may be electrically connected to the at least one server to provide power to the server. Furthermore, the data center provided in the embodiments of the present disclosure has the advantage of lower operation and maintenance costs.

The terms such as “upper” and “lower” used to describe relative positional relationships of various structures in the drawings are merely for the purpose of concise description rather than limiting the implementable scope of the present disclosure. The changes or adjustments of the relative relationship without a substantial modification to the technical solutions are regarded as being covered by the implementable scope of the present disclosure.

It is to be noted that in the present disclosure, unless specified or limited otherwise, a first feature “on” or “below” a second feature may include an embodiment in which the first feature is in direct contact with the second feature, and may also include an embodiment in which the first feature and the second feature are in indirect contact via an intermediary. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. A first feature “below,” “under,” or “on bottom of” a second feature may include an embodiment in which the first feature is right or obliquely “below,” “under,” or “on bottom of” the second feature, or just means that the first feature is at a height lower than that of the second feature.

In addition, in the present disclosure, unless specified or limited otherwise, terms “mounted”, “connected”, “coupled”, “fixed” and so on should be understood in a broad sense, which may be, for example, a fixed connection, a detachable connection or integrated connection, a direct connection or indirect connection by means of an intermediary, an internal communication between two elements or an interaction relationship between two elements. The specific significations of the above terms in the present disclosure may be understood in the light of specific conditions by persons of ordinary skill in the art.

Reference throughout this specification to the terms “an embodiment,” “some embodiments,” “an exemplary embodiment,” “an example,” “a specific example,” or “some examples,” means that a specific feature, structure, material, or characteristic described in connection with the embodiment or example is included in at least one embodiment or example of the present disclosure. The schematic representation of the above terms throughout this specification are not necessarily referring to the same embodiment or example. Furthermore, the specific features, structures, materials, or characteristics set forth may be combined in any suitable manner in one or more embodiments or examples.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, which does not make corresponding technical solutions in essence depart from the scope of the technical solutions of the embodiments of the present disclosure.

What is claimed is:

1. A power distribution device, comprising a first converter, a second converter, a DC energy accumulator, and a controller, wherein the first converter is configured to convert alternating current into direct current, and the second converter is configured to convert the direct current into the alternating current;
the first converter and the second converter are connected in series in a power supply circuit, an input terminal of the first converter is electrically connected to a power grid, an output terminal of the second converter is electrically connected to a load, and the DC energy accumulator is electrically connected between an output terminal of the first converter and an input terminal of the second converter; and
the controller is configured to control, based on a current electricity price and a state of the DC energy accumulator, to enable the DC energy accumulator and the second converter and disable the power grid and the first converter, such that the DC energy accumulator supplies power to the load; or the controller is configured to control to enable the power grid and the first converter and disable the DC energy accumulator and the second converter, such that the power grid supplies power to the load.

2. The power distribution device according to claim 1, further comprising a first monitor and a second monitor, wherein the first monitor is configured to obtain the current electricity price, and the second monitor is communicatively connected to the DC energy accumulator and is configured to obtain the state of the DC energy accumulator; and
the controller is communicatively connected to the first monitor and the second monitor, respectively, and the controller is configured to determine whether the current electricity price is higher than a preset electricity price based on the current electricity price obtained by the first monitor, and to determine whether the DC energy accumulator is in an operative state based on the state of the DC energy accumulator monitored by the second monitor; and the controller is further configured to control to enable the DC energy accumulator and the second converter and disable the power grid and the first converter when the current electricity price is higher than the preset electricity price and the DC energy accumulator is in the operative state, such that the DC energy accumulator supplies power to the load.

3. The power distribution device according to claim 2, wherein the second monitor is configured to monitor power of the DC energy accumulator and electric quantity of the DC energy accumulator; and
the controller is communicatively connected to the second monitor, and the controller is configured to determine, based on the power and the electric quantity of the DC energy accumulator monitored by the second monitor, whether the power of the DC energy accumulator is greater than power of the load and whether the electric quantity of the DC energy accumulator is greater than preset low electric quantity; and the controller is further configured to determine that the DC energy accumulator is in the operative state when the power of the DC energy accumulator is greater than the power of the load and the electric quantity of the DC energy accumulator is greater than the preset low electric quantity.

4. The power distribution device according to claim 3, further comprising an electric generator, wherein the electric generator is connected in parallel with the power grid at the input terminal of the first converter;
the controller is further configured to determine that the DC energy accumulator is in an inoperative state when the power of the DC energy accumulator is not greater than the power of the load and/or when the electric quantity of the DC energy accumulator is not greater than the preset low electric quantity; and
the controller is further configured to control to enable the electric generator and the first converter, disable the power grid and the first converter, and disable the DC energy accumulator and the second converter when the power grid is in a fault state and the DC energy accumulator is in the inoperative state, such that the electric generator supplies power to the load.

5. The power distribution device according to claim 4, further comprising a third monitor, wherein the third monitor is electrically connected to the power grid, and the third monitor is configured to monitor an electric current and a voltage of the power grid; and
the controller is communicatively connected to the third monitor, and the controller is configured to determine whether the power grid is in the fault state based on the electric current and the voltage of the power grid monitored by the third monitor.

6. The power distribution device according to claim 5, wherein the controller is further configured to control to enable the first converter and the second converter, enable the first converter and the DC energy accumulator, and disable the DC energy accumulator and the second converter when the current electricity price is not higher than the preset electricity price, such that the power grid supplies power to the load and the DC energy accumulator.

7. The power distribution device according to claim 5, further comprising a third converter, wherein the third converter is configured to convert a type of alternating current into another type of alternating current, and the third converter is connected in series between the second converter and the load.

8. The power distribution device according to claim 5, further comprising a fourth converter configured to convert a type of alternating current into another type of alternating current, wherein an input terminal of the fourth converter is connected in parallel with the input terminal of the first converter to the power grid, and an output terminal of the fourth converter is connected in parallel with the output terminal of the second converter to the load; and
the controller is communicatively connected to the fourth converter, and the controller is configured to control to enable the power grid and the fourth converter, enable the fourth converter and the load, disable the power grid and the first converter, and disable the second converter and the load when the first converter and/or the second converter are in the fault state.

9. The power distribution device according to claim 5, wherein the first converter is a rectifier, and the second converter is an inverter.

10. A data center comprising at least one server and a power distribution device, wherein an output terminal of the power distribution device is communicatively connected to the at least one server; the power distribution device, comprising a first converter, a second converter, a DC energy accumulator, and a controller, wherein the first converter is configured to convert alternating current into direct current, and the second converter is configured to convert the direct current into the alternating current;
the first converter and the second converter are connected in series in a power supply circuit, an input terminal of the first converter is electrically connected to a power grid, an output terminal of the second converter is electrically connected to a load, and the DC energy accumulator is electrically connected between an output terminal of the first converter and an input terminal of the second converter; and
the controller is configured to control, based on a current electricity price and a state of the DC energy accumulator, to enable the DC energy accumulator and the second converter and disable the power grid and the first converter, such that the DC energy accumulator supplies power to the load; or the controller is configured to control to enable the power grid and the first converter and disable the DC energy accumulator and the second converter, such that the power grid supplies power to the load.

11. The data center according to claim 10, further comprising a first monitor and a second monitor, wherein the first monitor is configured to obtain the current electricity price, and the second monitor is communicatively connected to the DC energy accumulator and is configured to obtain the state of the DC energy accumulator; and
the controller is communicatively connected to the first monitor and the second monitor, respectively, and the controller is configured to determine whether the current electricity price is higher than a preset electricity price based on the current electricity price obtained by the first monitor, and to determine whether the DC energy accumulator is in an operative state based on the state of the DC energy accumulator monitored by the second monitor; and the controller is further configured to control to enable the DC energy accumulator and the second converter and disable the power grid and the first converter when the current electricity price is higher than the preset electricity price and the DC energy accumulator is in the operative state, such that the DC energy accumulator supplies power to the load.

12. The data center according to claim 11, wherein the second monitor is configured to monitor power of the DC energy accumulator and electric quantity of the DC energy accumulator; and
the controller is communicatively connected to the second monitor, and the controller is configured to determine, based on the power and the electric quantity of the DC energy accumulator monitored by the second monitor, whether the power of the DC energy accumulator is greater than power of the load and whether the electric quantity of the DC energy accumulator is greater than preset low electric quantity; and the controller is further configured to determine that the DC energy accumulator is in the operative state when the power of the DC energy accumulator is greater than the power of the load and the electric quantity of the DC energy accumulator is greater than the preset low electric quantity.

13. The data center according to claim 12, further comprising an electric generator, wherein the electric generator is connected in parallel with the power grid at the input terminal of the first converter;
the controller is further configured to determine that the DC energy accumulator is in an inoperative state when the power of the DC energy accumulator is not greater than the power of the load and/or when the electric quantity of the DC energy accumulator is not greater than the preset low electric quantity; and
the controller is further configured to control to enable the electric generator and the first converter, disable the power grid and the first converter, and disable the DC energy accumulator and the second converter when the power grid is in a fault state and the DC energy accumulator is in the inoperative state, such that the electric generator supplies power to the load.

14. The data center according to claim 13, further comprising a third monitor, wherein the third monitor is electrically connected to the power grid, and the third monitor is configured to monitor an electric current and a voltage of the power grid; and
the controller is communicatively connected to the third monitor, and the controller is configured to determine whether the power grid is in the fault state based on the electric current and the voltage of the power grid monitored by the third monitor.

15. The data center according to claim 14, wherein the controller is further configured to control to enable the first converter and the second converter, enable the first converter and the DC energy accumulator, and disable the DC energy accumulator and the second converter when the current electricity price is not higher than the preset electricity price, such that the power grid supplies power to the load and the DC energy accumulator.

16. The data center according to claim 14, further comprising a third converter, wherein the third converter is configured to convert a type of alternating current into another type of alternating current, and the third converter is connected in series between the second converter and the load.

17. The data center according to claim 14, further comprising a fourth converter configured to convert a type of alternating current into another type of alternating current, wherein an input terminal of the fourth converter is connected in parallel with the input terminal of the first converter to the power grid, and an output terminal of the fourth converter is connected in parallel with the output terminal of the second converter to the load; and
the controller is communicatively connected to the fourth converter, and the controller is configured to control to enable the power grid and the fourth converter, enable the fourth converter and the load, disable the power grid and the first converter, and disable the second converter and the load when the first converter and/or the second converter are in the fault state.

18. The data center according to claim 14, wherein the first converter is a rectifier, and the second converter is an inverter.
